(19) United States
(12) Patent Application Publication
(10) Pub. No.: US 2003/0173830 A1
(43) Pub. Date: Sep. 18, 2003

(54) Temperature and barometric responsive fan system

(75) Inventors: Christopher S. Smith, Mission Viejo, CA (US); Sylvester T. Yu, Anaheim, CA (US); George Bertram Dodson III, Glendale, CA (US)

Correspondence Address: Fogg Slifer Polglaze Leffert & Jay, P.A., P.O. Box 581009, Minneapolis, MN, 55458-1009, US

(73) Assignee: ADC DSL Systems, Inc.

(21) Appl. No.: 10/100,352

(22) Filed: Mar. 18, 2002

(51) Int. Cl. H02B 1/24

(52) U.S. Cl. 307/117

(57) ABSTRACT

A management system and method are provided to adjust fans used for cooling equipment. The system includes one or more electric fans. The operational speed of the fan(s) is adjusted as the environmental parameters change. For example, the fan speed is increased as the temperature and elevation increase. In addition, fan failure circuitry provides a safe operation feature that increases fan supply voltage when a performance failure is detected.

### FIELD OF THE INVENTION

The present invention relates generally to electronic equipment and in particular the present invention relates to management of fan cooling for electronic equipment.

### BACKGROUND OF THE INVENTION

In high power density electronic systems, it frequently becomes necessary to use forced air-cooling to prevent equipment overheating. Heat sinks and electric fans are typically used to dissipate the heat generated by the electronic equipment. Some systems, such as telecommunication equipment, have maximum acoustic noise restrictions. These restrictions are primarily directed at the noise produced by the electric fan(s) used to cool the equipment. Often the cooling requirements and noise restrictions cannot all be satisfied simultaneously.

Additionally, failure of cooling system components may interrupt service and is highly undesirable. Management of the system cooling, therefore, is necessary. For the reasons stated above, and for other reasons stated below which will become apparent to those skilled in the art upon reading and understanding the present specification, there is a need in the art for a system and method of managing an electronic equipment cooling system.

### SUMMARY OF THE INVENTION

The above-mentioned problems with electronic equipment cooling systems and other problems are addressed by the present invention and will be understood by reading and studying the following specification.

In one embodiment, an air-cooling system comprises an electric fan, and a control circuit coupled to adjust an operating speed of the electric fan based on a measured temperature and atmospheric elevation of the air-cooling system.

In another embodiment, a cooling system comprises first and second electric fans, first and second power supplies respectively coupled to the first and second electric fans, and a power supply adjustment circuit coupled to provide a control signal to the first and second power supplies. The power supply adjustment circuit increases power supply output voltages from the first and second power supplies in response to an increase in either temperature or atmospheric elevation.

A method of managing a cooling system comprises establishing an electric fan operating speed at room temperature, measuring a temperature of the cooling system, measuring an elevation of the cooling system, and increasing the operational speed when the measured temperature increases above room temperature or the measured elevation is above sea level.

### BRIEF DESCRIPTION OF THE DRAWINGS

FIG. 1 illustrates electrical equipment including active components and an air-cooling system according to an embodiment of the present invention;

FIG. 2 illustrates a block diagram of a controller for controlling one or more cooling fans according to an embodiment of the present invention; and

FIG. 3 further illustrates an embodiment of the controller of FIG. 2.

### DETAILED DESCRIPTION OF THE DRAWINGS

In the following detailed description of the preferred embodiments, reference is made to the accompanying drawings, which form a part hereof, and in which is shown by way of illustration specific preferred embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims.

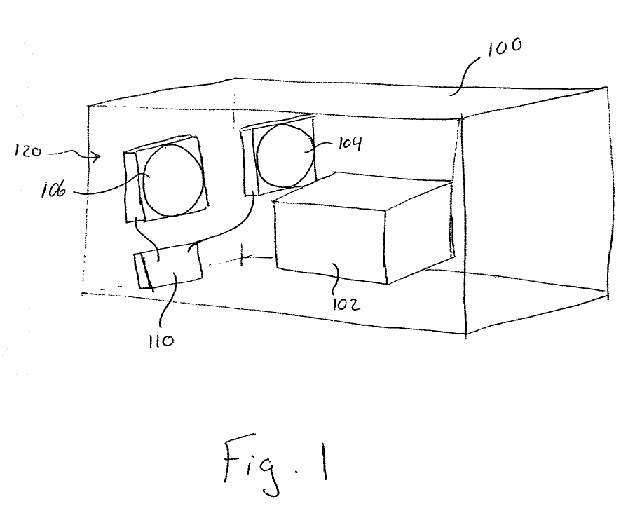

Referring to FIG. 1, electrical equipment 100 is illustrated that includes active components 102 and an air-cooling system 120. The active components 102, illustrated as a block, typically produce heat as a by-product of operation, and can include, but is not limited to, semiconductors, processors, transformers, switches and motors. The air-cooling system 120 includes one or more fans 104/106 to circulate air through the equipment and control circuitry 110 to monitor and adjust operating speeds of the fans.

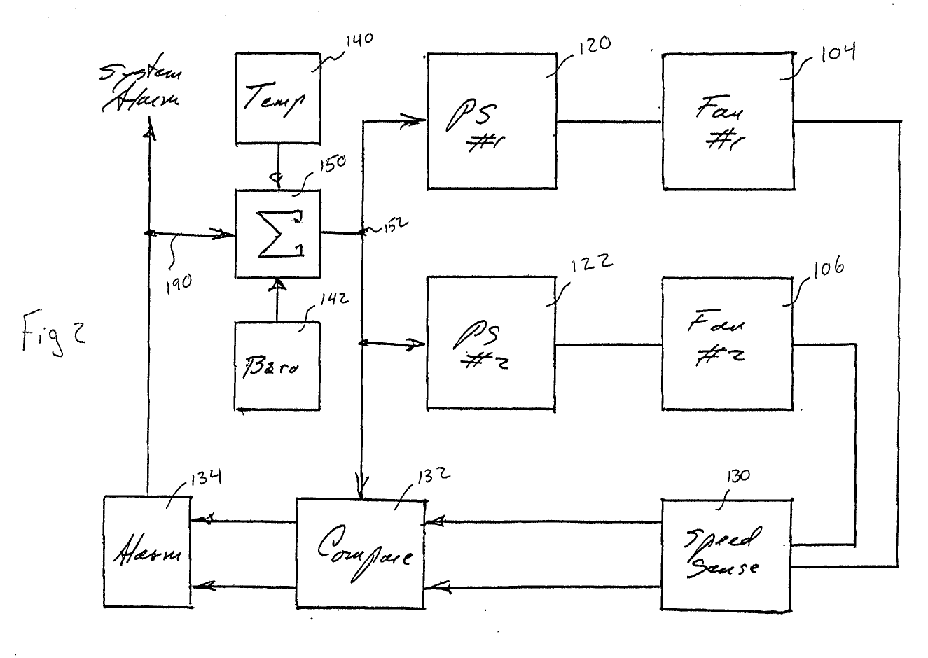

Referring to FIG. 2, a block diagram of the control circuitry is illustrated and described for controlling two cooling fans 104 and 106. The two fans are independently powered from separate dedicated power supplies 120/122 to provide system redundancy in the event of a fan or power component failure. The fan speed can be varied by adjusting its DC supply voltage. For example, the supply voltage can be changed over a range of 6V to 14V to change the fan speed. In one embodiment, the fan supply voltage is a nominal 10 volts to provide adequate system cooling at 25° C. and sea level elevation. The fan voltage, however, in one embodiment is limited to no less than 10 volts. When either the temperature or elevation increases, the fan voltage is increased. For example, the fan voltage is 14 volts at 45° C. at sea level, 25° C. at 11,000 ft altitude, or lesser combinations of temperature and altitude.

Fan 104 is powered by adjustable power supply 120. Likewise, fan 106 is powered by adjustable power supply 122. The power supplies are controlled, as explained below, to allow for better cooling of equipment as temperature and elevation change. As stated above, acoustical noise limitations often limit the speeds of the fans at room temperature. These noise limitations are often not specified at temperatures above room temperature (25° C.).

Speed sensing circuitry 130 is provided to measure the operating speed of the fans. It will be appreciated, that the efficiency of the fans may deteriorate with age. This can result in a reduced operating speed for a given input voltage. In addition, the fans can suffer from an operational failure and stop cooling the equipment. The speed sensing circuitry is coupled to provide the measured speed of the fans to a comparator circuit 132. The comparator determines if either of the fans is operating at a speed that is below the desired speed.

A fan reference voltage 152 is applied to a voltage to frequency converter provided in comparator circuit 132, which provides a fan reference speed clock. The fan reference speed clock is compared by a processor in comparator circuit 132 to determine if fan performance is normal. Whenever a fan speed is below 75% of nominal, an alarm condition is generated to adjust system parameters and to signal for system maintenance. The present invention is not limited to 75%, but can be any desired level of the nominal speed, such as 60, 70, 80 or 90%. Under alarm conditions, system parameters are adjusted so as to increase all fans to maximum speed to compensate for failed components until service can be performed. Control circuit 150 provides the control signal to the power supply, as explained below. The control circuit uses a temperature sensor 140 and a barometric sensor 142 to adjust the fan operating speed.

It will be appreciated by those skilled in the art, with the benefit of the present description, that the system can control more than two fans. The specification has been simplified to better understand the present invention. In addition, the present invention can be implemented on a single fan to adjust the based on temperature and elevation. The failure detection circuitry can still be implemented in this embodiment.

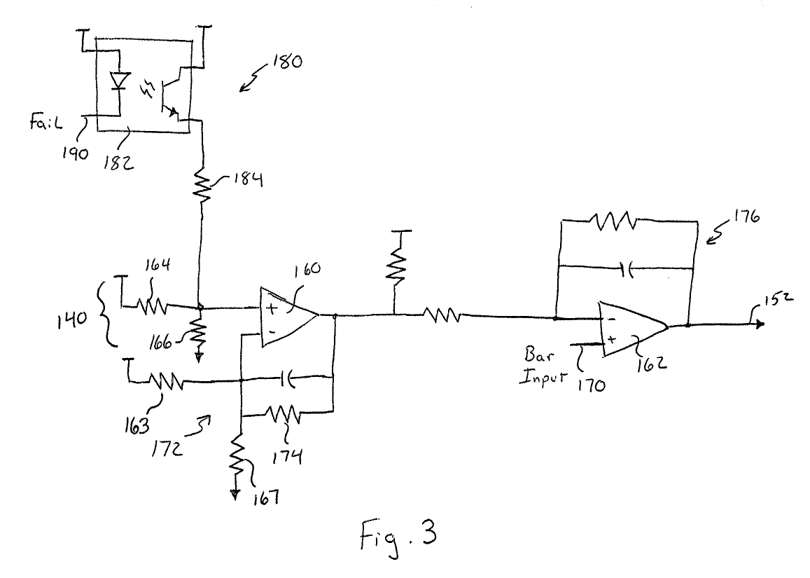

Referring to FIG. 3, a schematic diagram of one embodiment of the control circuit 150 and temperature sensor 140 are illustrated. The control circuitry includes a temperature adjustment circuit, an elevation adjustment circuit and a fan failure circuit. In general, the controller provides a fan speed control signal 152 that increases the fan speed as the temperature and/or altitude increase. If a fan failure is experienced by one fan, the controller increases the speed of the remaining fan to compensate for the reduced cooling capacity.

A first amplifier circuit 160 is used to generate a portion of the fan control signal. A resister divider circuit 164/166 is coupled to the positive input of the amplifier to perform as the temperature sensor 140. The resister divider includes a thermistor 164 (thermal resistor) that changes resistance with temperature. As the temperature increases above 25° C. (room temperature), the resistance decreases to increase the voltage on the amplifier (+) input. The amplifier negative input also includes a resistor divider circuit 163/167 that is more temperature stable than resister divider circuit 164/166. A gain resistor 174 is coupled between this input and the amplifier output. In operation, the amplifier output voltage increases as the temperature increases above 25° C.

A second amplifier circuit 162 is coupled to receive the first amplifier output and a barometric input 170 from circuit 142 (FIG. 2). The amplifier is biased to a maximum output voltage at room temperature and sea level. That is, the output voltage 152 decreases as a result of increasing temperature and/or an increasing elevation (barometer signal voltage decreases). In one embodiment, the fan control output voltage is at about 7 volts nominal (25° C., sea level) and can decrease to 0 volts based on temperature and elevation. This reduced output voltage is used to increase fan speed. That is, there is an inverse relationship between the fan control output signal voltage 152 and the fan speed. The voltage supply circuit 120/122 that provides a supply to the fan uses the fan control signal to adjust the fan supply voltage.

A motor fail-safe circuit 180 is provided to force the fan control signal 152 to its low voltage range. In the above embodiment, output voltage 152 is forced to 0 volts when a fan alarm is provided. The fail-safe circuit includes an optically coupled relay 182 that is coupled to pull the positive input of the first amplifier 160 to a high voltage. The relay is normally turned off to prevent current from flowing to the amplifier through resistor 184. The relay is activated when the fan failure signal 190 goes low to indicate that a fan has failed to operate at a predetermined performance level, see FIG. 2. The fan failure signal activates the relay diode and the relay output couples amplifier 160 positive input high. As a result, the speed control signal 152 is forced to 0 volts and the fan speed is increased to a maximum. This fail-safe operation allows the remaining fan(s) to compensate for some of the lost cooling capacity due to the failed fan. Again, the failure detection circuitry indicates when a fan is below an operational threshold, and is not limited to non-operational failures.

It will be appreciated by those skilled in the art, with the benefit of the present disclosure, that the circuitry can be modified without departing from the present invention. For example, the fail-safe circuit can be modified to directly pull the speed control signal low, instead of changing the amplifier input voltage.

### Conclusion

A management system and method have been described to adjust fans used for cooling equipment. The system includes one or more electric fans. The operational speed of the fan(s) is adjusted as the environmental parameters change. For example, the fan speed is increased as the temperature and elevation increase. In addition, fan failure circuitry provides a safe operation feature that increases fan supply voltage when a performance failure is detected.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. An air-cooling system comprising:
an electric fan; and
a control circuit coupled to adjust an operating speed of the electric fan based on a measured temperature and atmospheric elevation of the air-cooling system.

2. The air-cooling system of claim 1 wherein the control circuit comprises:
a power supply coupled to the electric fan; and
a power supply adjustment circuit coupled to provide a control signal to the power supply, the power supply adjustment circuit increases an output voltage of the power supply in response to an increase in either temperature or atmospheric elevation.

3. The air-cooling system of claim 2 wherein the power supply adjustment circuit increases the power supply output voltage in response to a fan failure input signal.

4. The air-cooling system of claim 3 where the fan failure input signal indicates that a second electric fan has suffered an operational failure.

5. The air-cooling system of claim 2 wherein the power supply adjustment circuit comprises:
first and second series coupled voltage amplifier circuits, an input of the second amplifier circuit is coupled to receive a barometric pressure signal; and
a thermistor coupled to an input of the first voltage amplifier.

6. A cooling system comprising:
first and second electric fans;
first and second power supplies respectively coupled to the first and second electric fans; and
a power supply adjustment circuit coupled to provide a control signal to the first and second power supplies, the power supply adjustment circuit increases power supply output voltages from the first and second power supplies in response to an increase in either temperature or atmospheric elevation.

7. The cooling system of claim 6 wherein the power supply adjustment circuit comprises:
first and second series coupled voltage amplifier circuits, an input of the second amplifier circuit is coupled to receive a barometric pressure signal; and
a thermistor coupled to an input of the first voltage amplifier.

8. The cooling system of claim 7 wherein the power supply adjustment circuit further comprises a fail-safe circuit to increase the power supply output voltages in response to a fan failure input signal.

9. The cooling system of claim 8 where the fan failure input signal indicates that either the first or second electric fan has suffered an operational failure.

10. The cooling system of claim 8 wherein the fail-safe circuit comprises a pull-up circuit coupled to an input of the first voltage amplifier.

11. The cooling system of claim 6 further comprises:
a speed sensor circuitry coupled to the first and second electric fans;
a comparator circuit coupled to the speed sensor circuitry to compare a measured operational speed of the fans to a desired operating speed; and
an alarm circuit coupled to the comparator circuit to generate a fan failure signal indicating that either the first or second electric fan has suffered a performance failure.

12. An air-cooling system including an electric fan comprising a control circuit coupled to adjust an operating speed of the electric fan based on a measured temperature and atmospheric elevation of the air-cooling system.

13. An air-cooling system including an electric fan comprising a control circuit coupled to adjust an operating speed of the electric fan based on a measured temperature and atmospheric elevation of the air-cooling system, the control circuit further increases the operating speed of the electric fan if an electric fan speed performance failure is detected.

14. A method of managing a cooling system comprising:
establishing an electric fan operating speed at room temperature;
measuring a temperature of the cooling system;
measuring an elevation of the cooling system; and
increasing the operational speed when the measured temperature increases above room temperature or the measured elevation is above sea level.

15. The method of claim 14 further comprises:
measuring the fan actual operating speed; and
increasing the operational speed when the fan actual speed is below a threshold level of the electric fan operating speed.

16. The method of claim 14 wherein the electric fan operating speed is established and increased by controlling a power supply coupled to the fan.

17. A method of managing a cooling system comprising:
establishing an electric fan operating speed at room temperature;
measuring a temperature of the cooling system; and
increasing the operational speed when the measured temperature increases above room temperature.

18. The method of claim 17 further comprises:
measuring the fan actual operating speed; and
increasing the operational speed when the fan actual speed is below a threshold level of the electric fan operating speed.

19. An air-cooling system including an electric fan comprising:
a control circuit coupled to adjust an operating speed of the electric fan based on a measured temperature and atmospheric elevation of the air-cooling system, the control circuit comprises,
a first voltage amplifier circuit having first and second inputs,
a first voltage divider circuit is coupled to the first input of the first amplifier circuit,
a second voltage divider circuit is coupled to the second input of the first amplifier circuit, the second voltage divider circuit includes a thermister, and
a second voltage amplifier circuit having first and second inputs, the first input of the second amplifier circuit is coupled to an output of the first voltage amplifier circuit, and the second input of the second amplifier circuit is coupled to receive a barometric pressure signal.

20. The air-cooling system of claim 19 wherein the control circuit further comprises a fan failure circuit coupled to the second input of the first amplifier circuit to increases the operating speed of the electric fan if an electric fan speed performance failure is detected.
